(19) United States
(12) Patent Application Publication
(10) Pub. No.: US 2014/0145852 A1
(43) Pub. Date: May 29, 2014

(54) PORT IDENTIFICATION

(71) Applicant: HEWLETT-PACKARD DEVELOPMENT COMPANY, L.P., Houston, TX (US)

(72) Inventors: Robert Scott WRIGHT, Spring, TX (US); Hiep Nguyen, Houston, TX (US); Nam Hoang Nguyen, Houston, TX (US)

(73) Assignee: Hewlett-Packard Development Company, L.P., Houston, TX (US)

(21) Appl. No.: 13/689,264

(22) Filed: Nov. 29, 2012

(51) Int. Cl. G08B 21/18

(52) U.S. Cl. CPC G08B 21/18
USPC 340/635

(57) ABSTRACT

In one example implementation, a system is provided. The system includes a port, a light source proximate in the port, a BIOS to enable a port configuration to be set, and a port identification module. The port identification module is to detect the port configuration, and cause the light source to illuminate based on the port configuration.

### BACKGROUND

In computing, a serial port is a serial communication physical interface through which information transfers in or out one bit at a time. The serial port is often compliant with the RS-232 standard, and generally connects a computing device to a peripheral device (e.g., a display, an uninterruptible power supply (UPS), a printer, etc.). While less common in current personal computers due to the development of the universal serial bus (USB) and FireWire, serial ports are still widely used in, for example, industrial devices, servers, retail point of sale devices, and scientific instruments at least because serial ports are inexpensive, simple, highly standardized, and widespread.

### BRIEF DESCRIPTION OF THE DRAWINGS

Examples are described in the following detailed description and in reference to the drawings, in which:

FIG. 1 depicts an example system in accordance with an implementation;

FIG. 2 depicts an example retail point of sales system in accordance with an implementation;

FIG. 3 depicts an example process flow diagram in accordance with an implementation;

FIG. 4 depicts an example process flow diagram in accordance with another implementation;

FIG. 5 depicts a port identification module in accordance with an implementation; and

FIG. 6 depicts a port identification module in accordance with another implementation.

### DETAILED DESCRIPTION

Various aspects of the present disclosure are directed to port identification. In particular, various aspects of the present disclosure are directed to a novel and previously unforeseen approach to identify the current configuration of a particular port.

Current serial ports are available in non-powered and powered versions. Powered serial ports are beneficial because they can be independently configured to deliver power (e.g., 5 volts or 12 volts) to compatible devices, thereby eliminating the need for the external power supply bricks that are required with non-powered implementations. While many see this as an advantage over non-powered serial ports, one potential disadvantage of powered serial ports is that they may cause damage to devices if improperly utilized. For example, if a user plugs a non-powered serial device into a powered serial port, the non-powered serial device and/or device hosting the powered serial port may be damaged. This may occur quite often because users commonly forget port settings when both powered and non-powered serial ports are utilized.

Current solutions to the above-mentioned issue involve providing warnings in the technical documents associated with the product and/or placing a label next to the port indicating whether the port is powered or non-powered. The warning in the technical documents, however, is ineffective because users generally do not read through all the technical documents. Similarly, the labels next to the ports are ineffective because the non-powered/powered configuration of a port may change, and users typically neglect to update the labels according to the changes.

Aspects of the present disclosure provide a solution to the foregoing problem by introducing an architecture that indicates the status of a particular port in a user-friendly and effective manner. In particular, aspects of the present disclosure utilize a port identification module to detect the current configuration of a port, and to cause a light source proximate to the port to illuminate based on the port configuration. The port identification module may detect the current port configuration by, for example, determining the current port setting in the Basic Input/Output System (BIOS) (e.g., 0 volt, 5 volt, 12 volt, etc.). Based on the detected port setting, the port identification module may cause the light source to illuminate a different color (e.g., 0 volt=OFF, 5 volt=yellow, and 12 volt=green) and/or at a different frequency (e.g., 0 volt=OFF, 5 volt=blink ON/OFF, and 12 volt=ON). Thus, a user viewing the port and associated light source can quickly and effortlessly identify the current port setting by determining the status of the light source (e.g., OFF, ON, yellow, green, blinking, etc.), and therefore refrain from misconnecting a plug and damaging the associated device. This benefit, along with other benefits, is discussed further below with reference to various example implementations and figures.

In one example implementation, a system is provided. The system comprises a port, a light source proximate to the port, a BIOS to enable a port configuration to be set, and a port identification module. The port identification module is to detect the port configuration, and cause the light source to illuminate based on the port configuration. The port may be a serial port and may illuminate a different color based on the port configuration.

In another example implementation, a retail point of sales (RPoS) system is provided. The RPoS system comprises a plurality of ports, a plurality of light sources (where each of the plurality of light sources is proximate to one of the plurality of ports), a BIOS to enable a port configuration to be set for each of the plurality of ports, and a port identification module. The port identification module is to detect the port configuration for each of the plurality of ports, and illuminate the light sources proximate to the plurality of ports based on the port configuration for the respective ports.

In yet another example implementation, a process is provided. The process comprises receiving, at a BIOS, a port configuration setting; detecting, by a port identification module, the port configuration setting; and causing, by the port identification module, a light source proximate to a port to illuminate based on the port configuration setting.

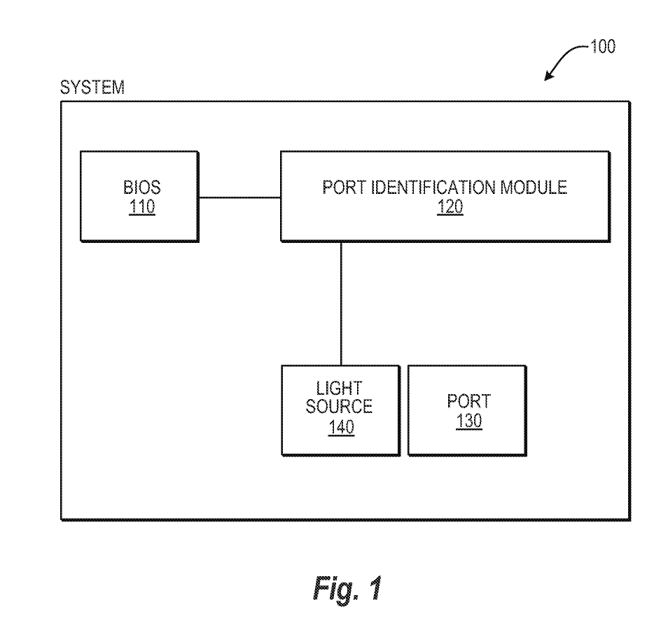

FIG. 1 depicts an example system 100 in accordance with an implementation. It should be readily apparent that the system 100 represents a generalized illustration and that other elements may be added or existing elements may be removed, modified, or rearranged without departing from the scope of the present disclosure. For example, while the system 100 depicted in FIG. 1 includes only a single port, the system 100 may actually comprise a plurality of ports, and only one has been shown and described for simplicity.

The system 100 comprises a BIOS 110, a port identification module 120, a port 130, and a light source 140. The BIOS 110 may be embodied on a chip on a motherboard, and may comprise machine readable instructions to instruct a device (e.g., a computer, a retail point of sale device, a scientific instruments, etc.) how to perform various basic functions such as booting and keyboard control. Moreover, the BIOS 110 may identify and configure hardware such as hard drives, ports, floppy drives, optical drives. CPUs, memory, and the like. In one implementation, the BIOS 110 may allow a user to modify hardware configuration options via a setup utility. In particular, the user may utilize the BIOS setup utility to configure each port to be either powered or non-powered. In the case of powered, the user may select a specific voltage for the port. For example, the user may seta port to 5 volts, 12 volts, 24 volts, or any other applicable voltage. The user may then save this setting and exit the BIOS setup utility.

The port identification module 120 may be communicatively coupled to the BIOS 110. The port identification module 120 may detect the port configuration set in BIOS (e.g., non-powered, 5 volt, 12 volt, etc.) and cause the light source 140 to illuminate based on the detected port configuration. Depending on the implementation, the port identification module 120 may be hardware, software, or a combination of both. For example, in one implementation, the port identification module 120 may comprise at least a processing device and a memory. The processing device may correspond to a device that generally retrieves and executes the instructions stored in the memory (e.g., a central processing unit CPU), processor, microcontroller, or the like). The memory may correspond to any typical storage device that stores computer-implemented instructions, such as programming code or the like (e.g, a non-volatile memory, a volatile memory, or a storage device), and may be discrete from or integrated with the processing device. In another implementation, the port identification module 120 may comprise a functionally equivalent circuit such as an application-specific integrated circuit (ASIC). Moreover, in some implementations, the port identification module 120 may comprise a circuit that is coupled to the output of the BIOS. This circuit may “intercept” configuration commands sent directly or indirectly from the BIOS 110 to the port 130, and based on these intercepted configuration commands, cause the light source 140 to illuminate appropriately. In one example, the circuit may monitor activity on a general purpose input/output (GPIO) tied to the BIOS that is used for changing the port configurations, and based on this monitoring, cause the light source 140 to illuminate appropriately.

The light source 140 may be a light emitting device (LED), an incandescent light source, a fluorescent light source, a neon light source, or any other type of light source. In various implementations, the light source 140 may be located proximate to the port 130. In particular, some implementations utilize more than one light source 140 proximate to the port to signify the current port configuration. As used herein, proximate means a distance close to the port which enables a viewer to readily understand that the light source 140 and the port 130 are associated (e.g., the port and light source are less than 1 cm apart). The port 130 may be a serial port, a COM port, a RS-232 port, a DB9 port, and/or a DB25 port. The port 130 may be located on a desktop, laptop, point of sale device, scientific instrument, server, industrial machine, or the like.

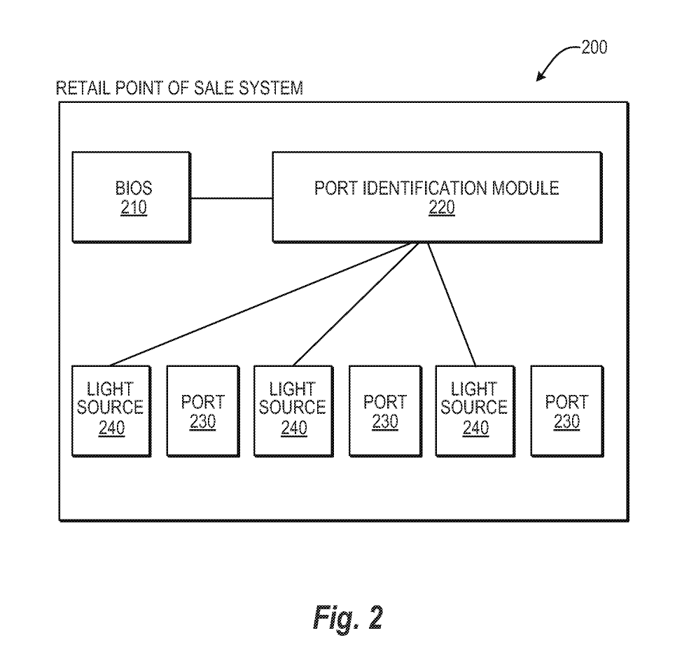

FIG. 2. depicts an example retail point of sale (RPoS) system 200 in accordance with an implementation. It should be readily apparent that the RPoS system 200 represents a generalized illustration and that other elements may he added or existing elements may be removed, modified, or rearranged without departing from the scope of the present disclosure. For example, the RPoS system 200 may comprise components not depicted such as a display, keyboard, cash register, scanner, credit card reader. CPU, memory, and other components typically associated with a RPoS system 200. These components were not included in FIG. 2 for simplicity and ease of understanding the present disclosure.

The RPoS system 200 in FIG. 2 is similar the system 100 depicted in FIG. 1. Thus, for the sake of brevity, the descriptions of the BIOS 210, port identification module 220, port 230, and light source 240 are incorporated from above. The difference in the implementation of FIG. 2 is that the RPoS system 200 includes a plurality of ports 230 and a plurality of light sources 240. The BIOS 210 enables a port configuration to be set for each of the plurality of ports 230, and the port identification module 220 is to detect the port configuration for each of the plurality of ports 230 and illuminate the light sources 240 proximate to the plurality of ports 230 based on the port configuration for the respective ports 230. Hence, a user viewing the RPoS system panel with the plurality of ports 230 can readily identify the current configuration of each port (e.g., non-powered, 5 volt, 12 volt, or 24 volt, etc.) by simply identifying the color/frequency of the respective light sources 240 (e.g., OFF, ON, yellow, green, blinking, etc).

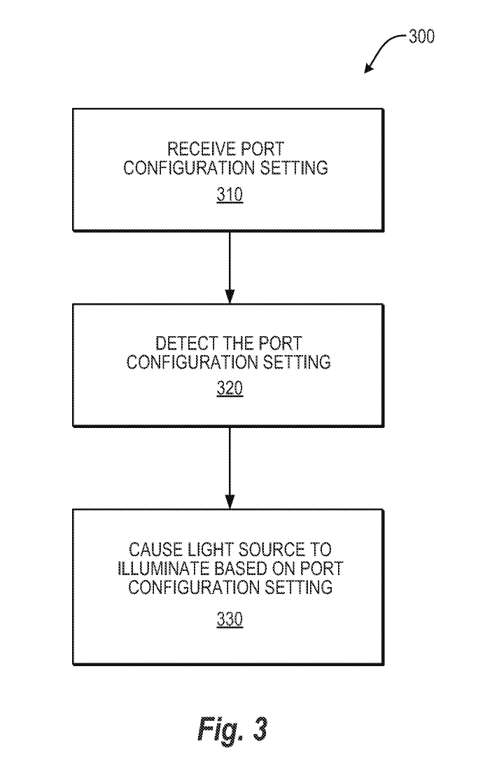

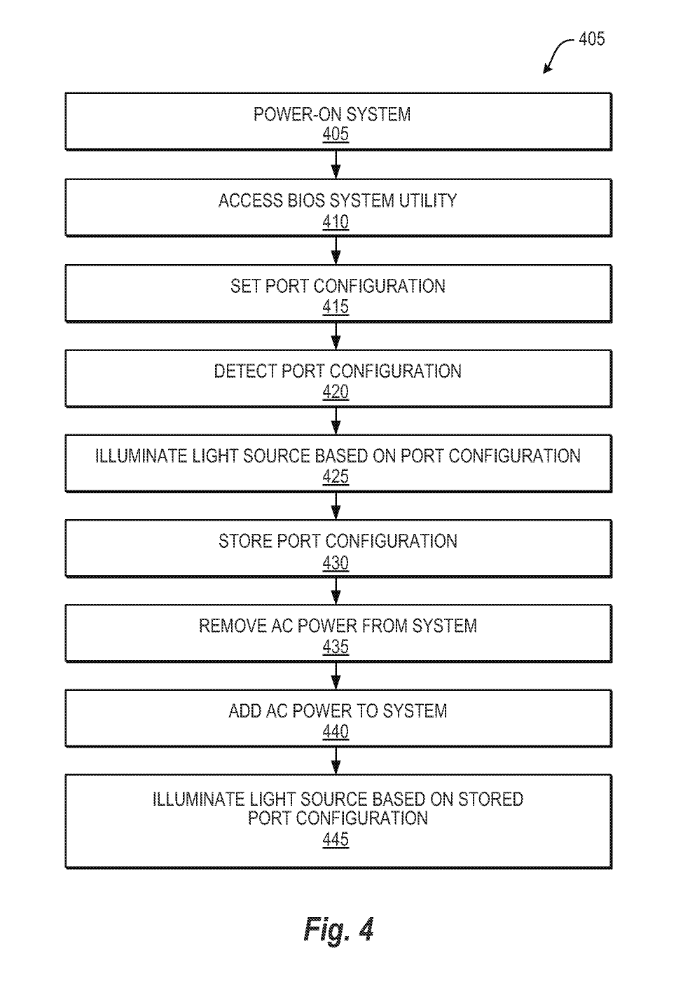

FIG. 3 depicts an example process flow diagram 300 in accordance with an implementation. It should be readily apparent that the processes depicted in FIG. 3 (as well as FIG. 4) represent generalized illustrations, and that other processes may be added or existing processes may be removed, modified, or rearranged without departing from the scope and spirit of the present disclosure. Further, it should be understood that the processes may represent executable instructions stored on memory that may cause a processing device to respond, to perform actions, to change states, and/or to make decisions. Alternatively or in addition, the processes may represent functions and/or actions performed by functionally equivalent circuits like an analog circuit, a digital signal processing device circuit, an application specific integrated circuit (ASIC), other logic devices associated with a port identification module. Furthermore. FIG. 3 (as well as FIG. 4) is not intended to limit the implementation of the described implementations, but rather the figure illustrates functional information one skilled in the art could use to design/fabricate circuits, generate software, or use a combination of hardware and software to perform the illustrated processes.

The process may begin at block 310, when a port configuration setting is received. This may occur when a user accesses a BIOS setup utility and sets a port configuration (e.g., non-powered or powered). In some instances, the port configuration may not change from a previous setting, so receiving the setting may involve receiving the port configuration as previously set or as set by default.

At block 320, the port identification module detects the port configuration setting. For example, the port identification module may communicate with the BIOS to determine the port configuration for a port. Alternatively or in addition, the port configuration module may “intercept” output signals from BIOS and use this information to determine the port configuration for a port.

At block 330, the port identification module causes a light source proximate to a port to illuminate based on the detected port configuration setting. In some implementations, this may involve the port identification module outputting a signal or command that directly or indirectly causes the light source to illuminate a particular color or at a particular frequency.

FIG. 4 depicts an example process flow diagram 400 in accordance with another implementation. In particular, FIG. 4 depicts a process whereby the port identification module stores the most recent port configuration settings such that the port identification module can cause the light source to immediately illuminate based on the stored settings upon receiving AC power and prior to the system being powered-up.

The process may begin at block 405, when the system is powered-up. At block 410, a user may access the BIOS system utility (e.g., by pressing the F10 key). At block 415, the user may set the port configuration (e.g., 0 volt, 5 volt, 10 volt, etc.) for a port. At block 420, the port identification module may detect the port configuration in the manner described above with respect to FIGS. 1-3. Thereafter, at block 425, the port identification module may cause the light source to illuminate based on the detected port configuration. Prior to, contemporaneously, or thereafter, at block 430, the port identification module may store the current or most recent port configurations. In one implementation, this may occur in hardware via latches. At block 435, the system is unplugged from AC power. Thereafter, at block 440, the system receives AC power. At block 445, the port identification module causes the light source to illuminate based on the port configurations stored at block 430. This is beneficial at least because it allows the light source to be correctly illuminated when the system receives AC power, but prior to the power button being depressed and/or prior to the system booting up.

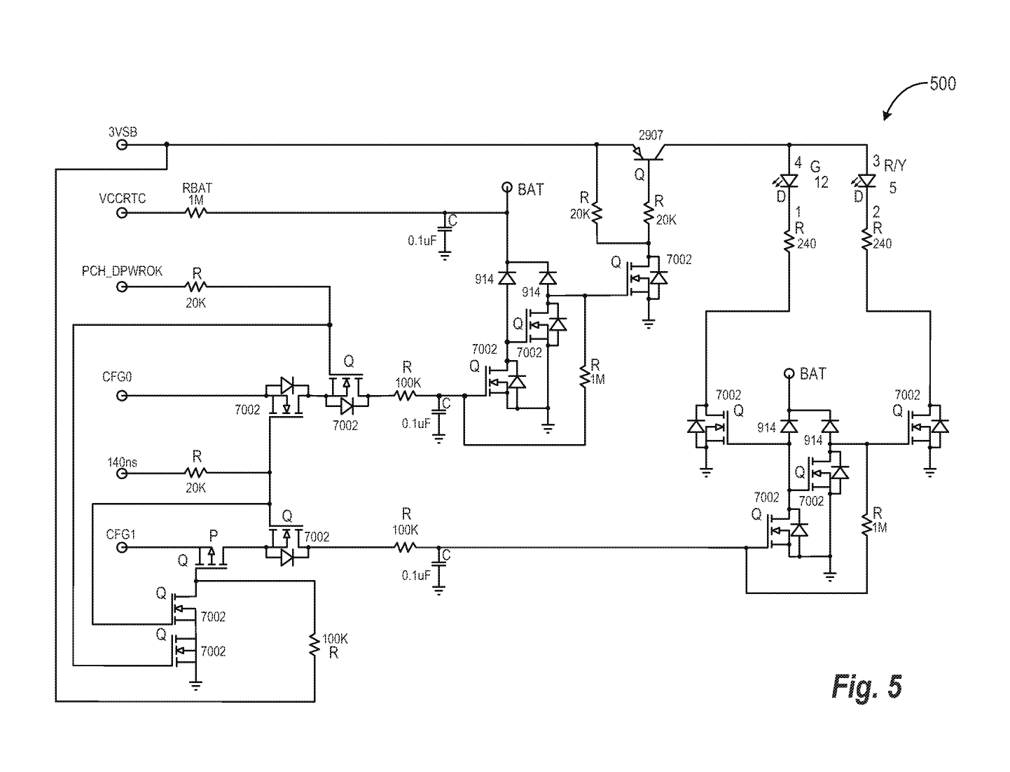

FIG. 5 depicts a port identification module 500 in accordance with an implementation. In particular, FIG. 5 depicts a hardware circuit configuration for the port identification module that includes latches to retain the most recent port configuration setting. This circuit may be coupled to the output of the BIOS to detect the port configuration set therein. Based on this detected information, the circuit may cause the light source(s) to illuminate in a manner that informs a viewer about the current port configuration.

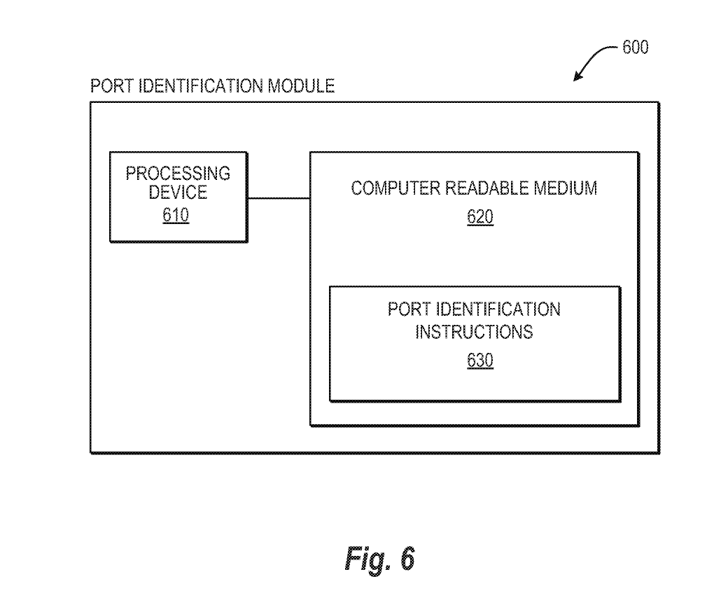

FIG. 6 depicts a port identification module 600 in accordance with another implementation. In this implementation, the port identification module 600 comprises a processing device 610 and a computer readable medium 620. The processing device 610 and computer readable medium 620 may either be integrated in a single component or discrete components. The computer readable medium 620 may comprise port identification instructions 630 that when executed cause the port identification module to conduct at least the functions described above with respect to FIGS. 1-4. The non-transitory computer readable medium 620 may correspond to any typical storage device that stores machine-readable instructions, such as programming code, software, firmware, or the like. For example, the computer-readable medium 440 may include one or more of a non-volatile memory, a volatile memory, and/or a storage device. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. The processing device 430 may be at least one of a central processing unit (CPU), a semiconductor-based microprocessor, a graphics processing unit (GPU), a microcontroller, a field-programmable gate array (FPGA) configured to retrieve and execute instructions, other electronic circuitry suitable for the retrieval and execution instructions stored on the computer readable medium 620, or a combination thereof.

As described in detail above, aspects of the present disclosure provide a an architecture that indicates the status of a particular port in a user-friendly and effective manner. In particular, aspects of the present disclosure utilize a port identification module to detect the current configuration of a port, and to cause a light source proximate to the port to illuminate based on the port configuration. The port identification module may detect the current port configuration by, for example, determining the current port setting in the BIOS (e.g., 0 volt, 5 volt, 12 volt, etc.). Based on the detected port setting, the port identification module may cause the light source to illuminate a different color (e.g., 0 volt=OFF, 5 volt=yellow, and 12 volt=green) and/or at a different frequency (e.g., 0 volt=OFF, 5 volt=blink ON/OFF, and 12 volt=ON). Thus, a user viewing the port and associated light source can quickly and effortlessly identify the current port setting by determining the status of the light source (e.g., OFF, ON, yellow, green, blinking, etc.), and therefore refrain from misconnecting a plug and damaging the associated device.

While the above disclosure has been shown and described with reference to the foregoing examples, it should be understood that other forms, details, and implementations may be made without departing from the spirit and scope of the disclosure that is defined in the following claims.

What is claimed is:

1. A system comprising:
a port;
a light source proximate to the port;
a BIOS to enable a port configuration to be set; and
a port identification module,
wherein the port identification module is to detect the port configuration, and cause the light source to illuminate based on the port configuration.

2. The system of claim 1, wherein the port is to operate in a powered mode or non-powered mode based on the port configuration.

3. The system of claim 1, wherein in the port is to operate in a non-powered mode, a 5 volt powered mode, or a 12 volt powered mode based on the port configuration.

4. The system of claim 1, wherein the port is a serial port.

5. The system of claim 1, wherein the port identification module is to store the port configuration, such that, when the system receives AC power, the port identification module is to illuminate the light source based on the stored port configuration.

6. The system of claim 1, wherein the system is a retail point of sale system.

7. The system of claim 1, wherein the port identification module is to cause the light source to illuminate a predetermined color based on the port configuration.

8. The system of claim 1, wherein the port identification module is to cause the light source to illuminate at a predetermined frequency based on the port configuration.

9. A method comprising:
receiving, at a BIOS, a port configuration setting;
detecting, by a port identification module, the port configuration setting; and
causing, by the port identification module, a light source proximate to a port to illuminate based on the port configuration setting.

10. The method of claim 9, further comprising:
storing, by the port identification module, the port configuration setting.

11. The method of claim 10, further comprising:
causing, by the port identification module, the light source proximate to the port to illuminate based on the stored port configuration setting upon receiving AC power.

12. The method of claim 9, wherein the port configuration setting is for a powered mode or a non-powered mode.

13. The method of claim 9, wherein the port is a serial port.

14. The method of claim 9, wherein the port configuration setting allows the port to operate in a non-powered mode, a 5 volt powered mode, or a 12 volt powered mode.

15. A retail point of sales (RPOS) system, comprising:
a plurality of ports;
a plurality of light sources, wherein each of the plurality of light sources is proximate to one of the plurality of ports;
a BIOS to enable a port configuration to be set for each of the plurality of ports; and
a port identification module,
wherein the port identification module is to detect the port configuration for each of the plurality of ports, and illuminate the light source proximate to each of the plurality of ports based on the port configuration for the respective port.

16. The RPOS system of claim 15, wherein the plurality of ports are serial ports.

17. The RPOS system of claim 15, wherein each of the plurality of ports is to operate in a powered mode or a non-powered mode based on the port configuration.

18. The RPOS system of claim 15, wherein the port identification module is to cause each of the plurality of light sources to illuminate, a predetermined color based on the port configuration.

19. The RPOS system of claim 15, wherein the port identification module is to store the port configuration for each of the plurality of ports.

20. The RPoS system of claim 19, wherein the port identification module is to cause each of the plurality of ports to illuminate based on the stored port configuration upon the RPoS system receiving AC power.
